(19) United States
(12) Patent Application Publication
(10) Pub. No.: US 2010/0289725 A1
(43) Pub. Date: Nov. 18, 2010

(54) APPARATUS FOR HOLDING AN IMAGE DISPLAY DEVICE FOR VIEWING MULTI-DIMENSIONAL IMAGES

(76) Inventor: Robert A. Levine, Guilford, CT (US)

Correspondence Address: O''Shea Getz P.C., 1500 MAIN ST. SUITE 912, SPRINGFIELD, MA, 01115, US

(21) Appl. No.: 12/777,833

(22) Filed: May 11, 2010

Related U.S. Application Data
(60) Provisional application No. 61/178,298, filed on May 14, 2009.

(51) Int. Cl. G09G 3/00; G02B 27/22

(52) U.S. Cl. 345/32; 359/462

(57) ABSTRACT

A viewer for use with a portable image display device that has an image display screen is provided. The viewer includes a first end panel, an image display device holder, a second end panel, a left viewing lens and a right viewing lens. The holder is attached to the first end panel. The second end panel has at least one aperture. The left and right viewing lenses are mounted relative to the second end panel, and each is aligned with the one or more apertures disposed within the second end panel. The lenses are aligned to view there through the image display screen of a display device held within the viewer. The viewer is configurable in a closed position wherein the first end panel and the second end panel are in relative close proximity and in one or more open positions wherein the first and second end panels are further apart from one another than in the closed position.

This application claims priority to, and hereby incorporates in its entirety, U.S. Provisional Application Ser. No. 61/178,298 filed on May 14, 2010.

### BACKGROUND OF THE INVENTION

1. Technical Field

The present invention relates to stereoscopic imagery in general, and to apparatus for holding and viewing images displayed on electronic image display devices in particular.

2. Background Information

Electronic images can be captured and viewed on devices having an image display device. Prior art cameras, including cell phones having a built-in camera, display the image on a screen in two-dimensions, where the user can see the same two-dimensional image with both eyes. Humans perceive three-dimensional (hereinafter “3D”) objects when the right eye perceives images slightly different than the left eye. The disparity between the perceived images results from a separation between pupils in the right and the left eyes and hence the images resulting from the two differing perspectives which are then combined by the viewers brain into a single image that is perceived as 3D.

### SUMMARY OF THE INVENTION

According to an aspect of the present invention, a viewer for use with a portable image display device that has an image display screen is provided. The viewer includes a first end panel, an image display device holder, a second end panel, a left viewing lens, and a right viewing lens. The holder is attached to the first end panel. The second end panel has at least one aperture. The left and right viewing lenses are mounted relative to the second end panel, and each is aligned with the one or more apertures disposed within the second end panel. The lenses are aligned to view there through the image display screen of a display device held within the viewer. The viewer is configurable in a closed position wherein the first end panel and the second end panel are in relative close proximity and in one or more open positions wherein the first and second end panels are further apart from one another than in the closed position.

### DESCRIPTION OF THE DRAWINGS

FIG. 1 is a diagrammatic planar illustration of a viewer embodiment shown in an open position.

FIG. 2 is a diagrammatic planar illustration of a viewer embodiment shown in a closed position.

FIG. 3 is a diagrammatic illustration of the second end panel of the viewer embodiment shown in FIGS. 1 and 2.

FIG. 4 is a diagrammatic illustration of the first end panel of the viewer embodiment shown in FIGS. 1 and 2.

### DETAILED DESCRIPTION OF THE INVENTION

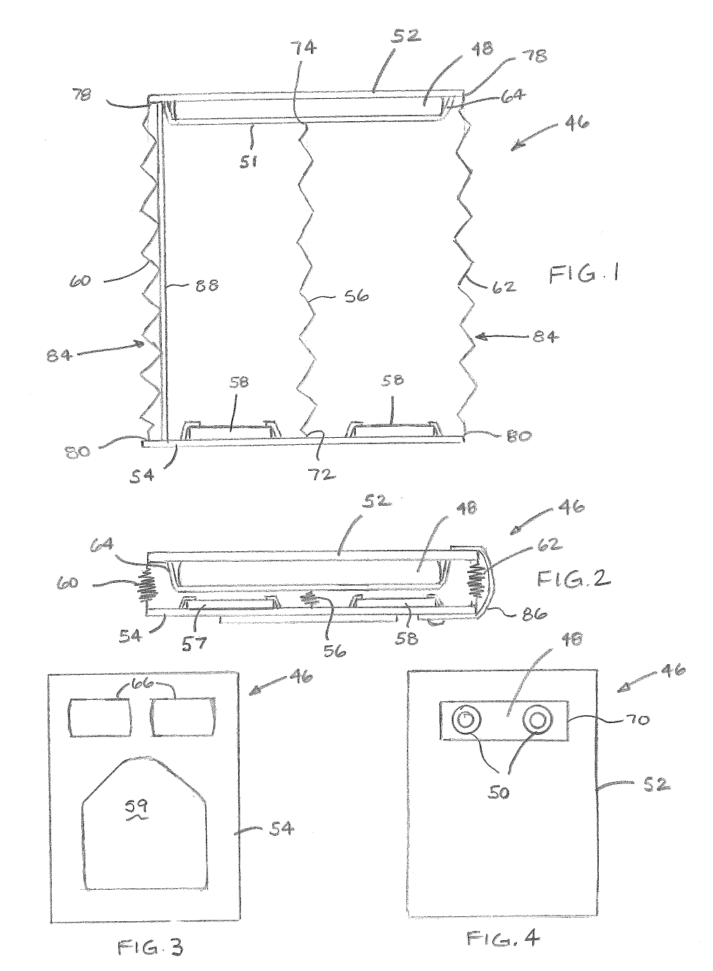

Now referring to FIGS. 1-4, a compact viewer 46 for multi-dimensional images (e.g., both 2 and 3 dimensional images) displayed on the display screen of a portable image display device 48 is provided. The term “image display device” is used herein to include electronic imaging devices as described above (e.g., devices such as cell phones that include a digital camera and a display screen, and digital cameras with displays that can both capture and display an image) and electronic devices operable to receive and display electronic images. For ease of description, the portable image display device 48 will be described hereinafter as a cell phone 48 having a pair of camera lenses 50 and a display screen 51, but the present invention is not limited to use with such a cell phone 48. The compact viewer 46 can function as a holder of the cell phone, and is preferably in a form that can be placed in a user's pocket or clipped to a user's belt, etc.

The compact viewer 46 includes a first end panel 52, a second end panel 54, a selectively collapsible barrier 56, a left viewing lens 57, and a right viewing lens 58. The lateral separation between the center of the viewing lens 57 and 58 ranges from about 1.6 to 3.2 inches, the same as the age dependent anatomic range for interpupillary distance. In some embodiments the viewer 46 also includes a first side panel 60 and a second side panel 62. A mechanism 64 for holding the image display device 48 (hereinafter referred to as the “holder 64”) relative to the first end panel 52 is disposed within an interior region of the viewer 46, adjacent the first end panel 52. The holder 64 is not limited to any particular embodiment, and acceptable examples include a pocket, mechanical fasteners, etc. The second end panel 54 has one or more apertures 66 (e.g., a pair of apertures 66 separated from one another; see FIG. 9). In those embodiments where there is more than one aperture 66, the apertures 66 are typically similar in size and disposed along a particular axis. The viewer 46 is configurable in a “closed” configuration, wherein the first and second end panels 52, 54 are relatively close to one another and the viewer 46 is not much larger than the enclosed cell phone 48. The viewer 46 is configurable in an “open” configuration, wherein the first and second end panels 52, 54 are separated a distance (e.g., anywhere from one to eight inches) from one another, thereby separating the viewing lenses from the display screen 51 of the image viewing device.

The viewing lenses 57, 58 are positive diopter type lenses ranging from or adjustable from two to ten diopters. The viewing lenses 57, 58 are mounted relative to the second end panel 54, with each lens 57, 58 aligned with one of the apertures 66. One or both lenses 57, 58 may also have a prismatic adjustment or correction to adjust the perception of the displayed image laterally which can improve the perception of three dimensionality. The lenses 58 may be adjustable in diopter to accommodate different users' needs, or alternatively different diopter lenses 58 can be selectively substituted. In some embodiments, the second end panel 54 has a geometry that includes a void 59 (or other structure) sized to accommodate the user's nose, thereby permitting the user to place the exterior surface of the second end panel 54 in closer proximity to the user's eyes.

In those embodiments where the image display device 48 includes a pair of lens 50 for capturing images, the first end panel 52 has at least one orifice 70 (see FIG. 4) positioned to align with the lenses 50, and thereby allow the image display device 48 (e.g., cell phone) to capture images while disposed within the viewer 46.

The collapsible barrier 56 is selectively configurable in a collapsed (i.e., “closed”) configuration (e.g., see FIG. 2) and a plurality of extended (i.e., “open”) configurations (e.g., see FIG. 1). In some embodiments, the barrier 56 may be configured in a collapsed configuration while the view 46 is in an open configuration (e.g., for 2D viewing). In the extended configurations of the barrier 56, the barrier 56 is positioned to limit the view of the display screen 51 through the left viewer lens 57 to a first area of the display screen of the image display device 48 which is less than all of the area of the display screen 51 of the image display device 48. At the same time, the barrier 56 is positioned to limit the view of the display screen 51 through the right viewer lens 58 to second area of the display screen 51 of the image display device 48 which is less than all of the area of the display screen 51 of the image display device. In preferred embodiments, the barrier 56 is positioned such that the first area visible through the left viewer lens 57 is about one-half the area of the image display screen 51, and the second area visible through the right viewer lens 58 is about one-half the area of the image display screen 51.

The above-described barrier configuration has particular utility for imaging devices that include a plurality of camera lenses and which are operable to take multiple different images of the same object from different perspectives. An example of such a device is described in U.S. patent application Ser. No. 12/354,491 which is hereby incorporated by reference in its entirety. The aforesaid device is operable to create an image comprising two separate images side by side of the same object, each image taken from a different perspective. When viewing such a combined image with the barrier 56 in an extended configuration, the present viewer 46 limits the field of vision of each eye of the user to the portion of the image corresponding to the same side as that particular eye; e.g., the barrier 56 limits the user's left eye to seeing the image taken by the left-side camera lens, and the user's right eye to seeing the image taken by the right-side camera lens.

The collapsible barrier 56 includes a first end 72 that, in some embodiments, is attached to the second end panel 54 between the apertures 66, and a second end 74 that is attached to one or both of the holder 64 and the first end panel 52. There is no requirement that the barrier 56 be attached to any of the second end panel 54, the holder 64, or the first end panel 52. Preferably, the barrier 56 is made from a relatively opaque and non-reflective material. The width of the collapsible barrier 56 extends between the first end 72 and the second end 74. The extension of the barrier 56 can be accomplished in a variety of different ways; e.g., a) the barrier may have a mechanical structure (e.g., a folder configuration typically referred to as “pleats”) that allows extension; or b) the barrier may be formed from an elastic material that has sufficient elasticity to stretch from, and memory to return to, its initial dimensions; or c) the barrier may be telescoping; or some combination thereof. The present invention is not limited to any of these examples.

In those embodiments where the viewer 46 includes side panels 60, 62, each side panel 60, 62 has a first end 78 attached to the first end panel 52 and a second end 80 attached to the second end panel 54. The width of the side panels 60, 62 extends between the first and second ends 78, 80. Like the barrier 56, the side panels 60, 62: 1) are “extendable” such that they can be extended from a collapsed closed position to one or more open positions, where the first and second end panels 52, 54 are further separated from one another; 2) can provide a continuous panel between the end panels 52, 54; and 3) can be extended in a variety of different ways like those described above relative to the barrier 56.

In some embodiments, a spring mechanism 84 is provided that is operable to bias the viewer 46 into an open position. An example of a spring mechanism 84 is shown in FIG. 1 in the form of one or more elastic structures that can be compressed, but are normally in an extended configuration associated with an open position of the viewer 46. One or both of the barrier 56 and the side panels 60, 62 may comprise such an elastic structure (e.g., the accordion-like pleats shown in FIG. 1, comprised of an elastic material), which biases the viewer 46 toward the open position. Alternatively, springs acting on the end panels 52, 54 could be used to bias the end panels 52, 54 away from one another. Closed cell foam, which has a spring-like behavior, is another example of a spring mechanism that could be used; i.e., foam disposed in the spaces surrounding the phone/camera to accomplish the same expansion and afford the surrounded device additional protection. Alternative spring mechanisms 84 include the use of diagonally placed rigid rods that are compressed when collapsed (line shaped) and “X” shaped when expanded. To close the viewer 46, force is applied to the end panels 52, 54 and the viewer 46 is compressed to a collapsed position.

When the viewer 46 is fully or partially collapsed, a locking device 86 (see FIG. 2) such as a Velcro® fastener or snaps may be used for maintaining the viewer 46 in a particular position. For example, the viewer 46 may be maintained in the closed position by the locking device 86, or the user can use the locking device 86 to maintain the viewer 46 in an open position. The degree of the open position can be selectively chosen to accommodate different users' visual needs; e.g., different near points (i.e., the closest position a person can comfortably focus on an image). The use of positive diopter type viewing lenses 57, 58 permits the user to comfortably view the display when the device is held anywhere within a distance of fractions of an inch to tens of inches from the user's eyes, but the perception of three dimensionality is present only when the viewer is held closely (e.g., held like binoculars are commonly held), to the user's eyes and the barrier 56 is sufficiently extended to restrict the field of view for each eye to the respective display.

In some embodiments, the viewer 46 includes a detent mechanism 88 (see FIG. 2) that can be collapsed in the closed position and expanded into one or more open positions. The detent mechanism 88 holds the position of the second end panel 54 (and therefore the viewing lenses 57, 58) relative to the first end panel 52. For those embodiments using a spring mechanism 84, the detent mechanism 88 is strong enough to maintain the relative positions of the end panels 52, 54 and thereby overcome the spring force of the spring mechanism 84. The detent mechanism 88 can have detent positions that are associated with particular incremental changes relative to the positioning of the viewing lenses 57, 58 and the image display device 48; e.g., +/−“n” diopters, etc.

For those embodiments of the viewer 46 that include one or more orifice 70 disposed within the first end panel 52 aligned with the camera lenses 50 of the cell phone 48, these embodiments permit images to be taken while the cell phone 48 is disposed within the viewer 46. The cameras of the cell phone 48 may, therefore, be used to capture static (or dynamic) images, at the same time the person taking the images is simultaneously viewing the images in 3D. In this operational mode, the person using the cell phone camera is able to operate the camera in a more natural picture taking mode; e.g., in a manner where an image is viewed as it would be through the optical view finder of a camera, in contrast to an image displayed on an electronic image display. The user holds the viewer containing the camera against or very near her eye when using the present invention viewer 46, rather than one to two feet away as is the case with many modern digital cameras. Most users will prefer this mode of taking pictures, rather than the holding of the camera one or two feet away from the photographer which is presently required when viewing electronic image display view finders.

In preferred embodiments, the viewer 46 includes openings positioned to permit the user to access the cell phone 48 input elements (e.g., buttons on the exterior of the cell phone 48 or other device) that provide access to defined functions such as on, off, mute, play, etc. provided with the device.

While various embodiments of the viewer have been described, it will be apparent to those of ordinary skill in the art that many more embodiments and implementations are possible within the scope of the viewer.

What is claimed is:

1. A viewer for use with a portable image display device that has an image display screen, comprising:
a first end panel;
an image display device holder, attached to the first end panel;
a second end panel, having one or more apertures;
a left viewing lens and a right viewing lens, both mounted relative to the second end panel, and each aligned with the one or more apertures disposed within the second end panel;
wherein both viewing lenses are aligned to view there through the image display screen of a display device held within the viewer; and
wherein the viewer is configurable in a closed position wherein the first end panel and the second end panel are in relative close proximity, and in one or more open positions wherein the first and second end panels are further apart from one another than in the closed position.

2. The viewer of claim 1, further comprising a selectively collapsible barrier positioned between the viewing lenses, and extendable in a direction toward the holder.

3. The viewer of claim 2, wherein in an extended configuration of the collapsible barrier, the barrier is positioned to limit the view of the display screen through the left viewing lens to less than all of the display screen, and the view of the display screen through the right viewing lens to less than all of the display screen.

4. The viewer of claim 3, wherein in the extended configuration the barrier is positioned to limit the view of the display screen through the left viewing lens to a first area of the display screen, and the view of the display screen through the right viewing lens to a second area of the display screen, which first and second areas are different from one another.

5. The viewer of claim 4, wherein each of the first and second areas are about one-half the area of the image display screen.

6. The viewer of claim 1, wherein the holder forms a pocket with an interior surface of the first end panel, which pocket is sized to receive the image display device.

7. The viewer of claim 1, wherein the viewing lenses are positive diopter lenses.

8. The viewer of claim 7, wherein the viewing lenses each have a diopter value that can be selectively adjusted.

9. The viewer of claim 1, further comprising a pair of side panels, each having a first end attached to the first end panel and a second end attached to the second end panel, which side panels have a width extending between the first end and the second end, and which side panels, and which side panels are extendable from the closed position to the one or more open positions.

10. The viewer of claim 9, wherein at least one of the collapsible barrier and the side panels includes pleats.

11. The viewer of claim 9, wherein at least one of the collapsible barrier and the side panels comprises an elastic material.

12. The viewer of claim 9, wherein at least one of the collapsible barrier and the side panels has a telescoping configuration.

13. The viewer of claim 1 further comprising a spring mechanism operable to bias the viewer into the one or more open positions.

14. The viewer of claim 13, wherein the spring mechanism includes a pair of pleated side panels each comprising an elastic material, and each having a first end attached to the first end panel and a second end attached to the second end panel, which side panels have a width extending between the first end and the second end, and which side panels, and which side panels are extendable from the closed position to the one or more open positions.

15. The viewer of claim 13, wherein the spring mechanism is located with the collapsible barrier.

16. The viewer of claim 13, further comprising a lock operable to maintain the relative positions of the first end panel and second end panel.

17. The viewer of claim 16, wherein the lock is operable to maintain the relative positions of the first end panel and second end panel when the viewer is in one of the open positions.

18. The viewer of claim 1, further comprising a detent mechanism operable to hold the first and second end panels in predetermined positions relative to one another.

19. The viewer of claim 1, wherein the first end panel includes one or more apertures positioned to align with a pair of camera lens disposed in the image display device, wherein the viewer is configured to allow simultaneous viewing of images in three-dimensional format as they are captured through the apertures disposed within the first end panel.

20. The viewer of claim 1, wherein the viewer is configured such that a user can comfortably see an image displayed on the image display screen at a range of distances between the viewing lenses and the user's eyes of less than one inch to about thirty inches.

21. The viewer of claim 1, wherein the viewer is configured to permit a user to capture an image of an object using the image display device while the viewer is in an open position, and at the same time view the object being imaged on the image display screen of the device.

22. The viewer of claim 21, wherein the viewer is configured to permit the user to position the viewer in close proximity to the user's face while viewing the image display screen of the device through the viewing lenses.

23. A system for viewing images in two or three dimensions, the system comprising:
a portable image display device that has an image display screen;
a viewer having a first end panel, a holder for the image display device holder, which holder is attached to the first end panel, a second end panel that has one or more apertures, a left viewing lens and a right viewing lens, both mounted relative to the second end panel, and each aligned with the one or more apertures disposed within the second end panel, wherein both viewing lenses are aligned to view there through the image display screen of the display device held within the viewer, and wherein the viewer is configurable in a closed position wherein the first end panel and the second end panel are in relative close proximity, and in one or more open positions wherein the first and second end panels are further apart from one another than in the closed position.

24. The system of claim 23, wherein the viewer is configured such that a user can comfortably see an image displayed on the image display screen at a range of distances between the viewing lenses and the user's eyes of less than one inch to about thirty inches.

25. The system of claim 23, wherein the viewer is configured to permit a user to capture an image of an object using the image display device while the viewer is in an open position, and at the same time view the object being imaged on the image display screen of the device.

26. The system of claim 25, wherein the viewer is configured to permit the user to position the viewer in close proximity to the user's face while viewing the image display screen of the device through the viewing lenses.
